(19) United States
(12) Patent Application Publication
(10) Pub. No.: US 2008/0223384 A1
(43) Pub. Date: Sep. 18, 2008

(54) PORTABLE MANICURIST WORK STATION AIR PURIFICATION APPARATUS WITH MAGNIFYING GLASS

(76) Inventor: LIDOR ZABARI, PETACH TIKVA (IL)

Correspondence Address: Lidor Zabari, 23 Kish Street, PETACH TIKVA, 49242, omitted

(21) Appl. No.: 12/110,454

(22) Filed: Apr. 28, 2008

(30) Foreign Application Priority Data
Oct. 29, 2006 (IL) PCT/IL2006/001240

(51) Int. Cl. A45D 29/00; B08B 15/00; F24F 7/06

(52) U.S. Cl. 132/73.5; 132/73; 454/49; 454/341

(57) ABSTRACT

A manicurist air purification apparatus with magnifying glass for improving a manicurist's working environment, which is simple, inexpensive and has efficient air sucking means to remove the toxic fumes, without impairing the manicurist hands movement.

### CROSS REFERENCE TO RELATED APPLICATIONS

This application claims the benefit under 35 USC 119(e) from U.S. provisional application 60/732,149 filed Nov. 2^{nd}, 2005, the disclosure of which is included herein by reference.

This application claims the benefit under 35 USC 371 from PCT application PCT/IL2006/001240 filed Oct. 29^{th}, 2006, the disclosure of which is included herein by reference.

### FIELD OF THE INVENTION

The present invention relates generally to beauty salon apparatus and equipment, and more specifically to an improved apparatus for use by manicurists in the application of nail polish, artificial nails and the like.

### BACKGROUND OF THE INVENTION AND PRIOR ART

The process of applying artificial fingernails generates organic and inorganic debris, as well as numerous contaminants. Known chemical contaminants for which there is a permissible exposure limit include: acetone, acetonitrile, benzoyl peroxide, ethyl acetate, ethyl ether, hydroquinone, methacrylic acid, 4-methoxyphenol, methylene chloride, methyl ethyl ketone, titanium dioxide, toluene, and 1, 1, 2-trichloro-1,2,2-trifluoroethane. Chemicals found in artificial nail products for which there are no permissible exposure limits include: butyl methacrylate, dimethyl p-toluidine, ethyl cyanoacrylate, ethyl methacrylate, ethylene glycol dimethacrylate, and isobutyl methacrylate. The treatment of human nails for aesthetic purposes may involve the application of a liquid acrylic, a liquid adhesive or other material to form a nail-like member.

The liquid acrylic, the liquid adhesive, the nail polish, the nail sealer, and other liquids employed by the manicurist give off noxious fumes. These fumes are objectionable to the client and manicurist. These fumes may prove harmful to the manicurist if exposed to such fumes over an extended period of time.

The existing nail and nail-like member must be trimmed, cut, and filed to the shape desired. One or more coats of nail polish and/or nail sealer must be applied to complete the nail in a form and finish which is aesthetically pleasing to the client.

Manicure workstations typically include a ventilation system which attempts to keep the air clean of such contaminants. They often include enclosed chambers to keep the fumes and debris away which makes them expensive, complex, bulky and inconvenient to use.

U.S. Pat. No. 6,708,697 to Ziff discloses a nail protector with a self enclosed workstation box which limits the manicurist's hand movement which impairs her professional abilities.

U.S. Pat. Nos. 6,444,002 to Mai, U.S. Pat. Nos. 5,336,128 to Birdsong and 5,464,029 to Rentz disclose manicurist's workstations which are complex, expensive and either limiting the manicurist's hand movement which impairs her professional abilities or have no magnifying means or have no vacuum means to remove the toxic fumes.

There is therefore a need for a manicurist air purification apparatus with magnifying glass to improve a manicurist's or other worker's working environment, and which is simple, portable, inexpensive, with efficient air sucking means to remove the toxic fumes and without impairing the worker's hands movement.

### SUMMARY OF THE INVENTION

It is thus the object of the present invention to provide a manicurist air purification apparatus with magnifying glass to improve the manicurist's working environment, and which is simple, portable, inexpensive, with efficient air sucking means to remove the toxic fumes and without impairing her hands movement.

An aspect of the present invention is to provide a portable apparatus.

An aspect of the present invention is to provide an apparatus for other professional workers that may inhale toxic fumes, such as workers that solder.

According to the teachings of the present invention there is provided an apparatus serving as a manicurist's workstation, the workstation including (a) a base; (b) one or more magnifying glasses; and (c) air and fume remover to eliminate most of these fumes from reaching either the manicurist or the client.

Further objects and advantages will become apparent from a consideration of the ensuing description and drawings.

### BRIEF DESCRIPTION OF THE DRAWINGS

The present invention will become fully understood from the detailed description given herein below and the accompanying drawings, which are given by way of illustration and example only and thus not limitative of the present invention.

FIG. 1 is a front perspective view of a mechanical embodiment of a worker's workstation according to the present invention, showing the inside part of the active area.

FIG. 2 is a front perspective view of a mechanical embodiment of a worker's workstation according to the present invention, showing the outside part of the active area.

FIG. 3 is a front perspective view of a mechanical embodiment of a worker's workstation according to the present invention, with better fume collection, showing the inside part of the active area.

FIG. 4 is a front perspective view of a mechanical embodiment of a worker's workstation according to the present invention, with better fume collection, showing the outside part of the active area.

FIG. 5 is a perspective view of another embodiment of a worker's workstation according to the present invention, showing the outside part of the active area.

FIG. 6 is a perspective view of yet another embodiment of a worker's workstation according to the present invention, showing the outside part of the active area.

FIG. 7 is a perspective view of yet another embodiment of a worker's workstation according to the present invention, showing the focus mechanism.

### DESCRIPTION OF THE PREFERRED EMBODIMENTS

Before explaining at least one embodiment of the invention in detail, it is to be understood that the invention is not limited in its application to the details of construction and the arrangement of the components set forth in the following description or illustrated in the drawings.

Unless otherwise defined, all technical and scientific terms used herein have the same meaning as commonly understood by one of ordinary skill in the art to which this invention belongs. The materials, methods, and examples provided herein are illustrative only and not intended to be limiting.

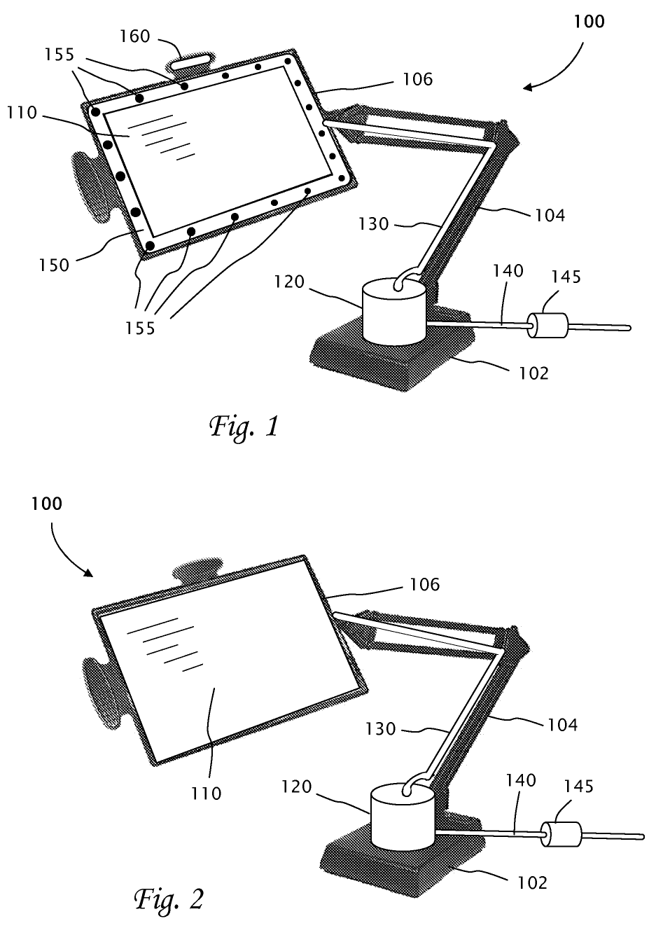

FIG. 1 is a front perspective view of a mechanical embodiment of a worker's workstation according to the present invention, showing the inside part of the active area, and FIG. 2 is a front perspective view of the same, but showing the outside part of the active area.

The apparatus 100, which serves as a manicurist's, soldering or other workstation, comprises a stable base 102, a flexible arm 104 and a working area frame 106. Said flexible arm 104 can also be a fixed arm but flexibility is preferred. Said working area frame 106 comprises a magnifying glass 110, which can be made of any appropriate clear material. Apparatus 100 further comprises a pump 120 which, on the one hand, extracts air and fumes from underneath the magnifying glass 110 and, on the other hand, exhaust said air and fumes away from the station via pipe 140, which may include a filter 145, to eliminate toxic fumes. Pump 120 extracts air and fumes from underneath the magnifying glass 110 via pipe 130 and a suction element 150 which is located at the rim of magnifying glass 110. The magnifying glass 110 blocks the fumes from rising further and makes it easier to removed from underneath it. For the sake of clarity, pump 120 can be positioned anywhere and not necessarily as shown in the drawings. Such an element 150 contains suction holes 155 which suck the air and fumes from underneath the magnifying glass 110. Said suction holes 155 are sized to maximize the suction efficiency. For example, the holes 155 which are further from the pump are larger then those closer to the pump. Optionally, apparatus 100 may also include a lamp 160 to illuminate the working area.

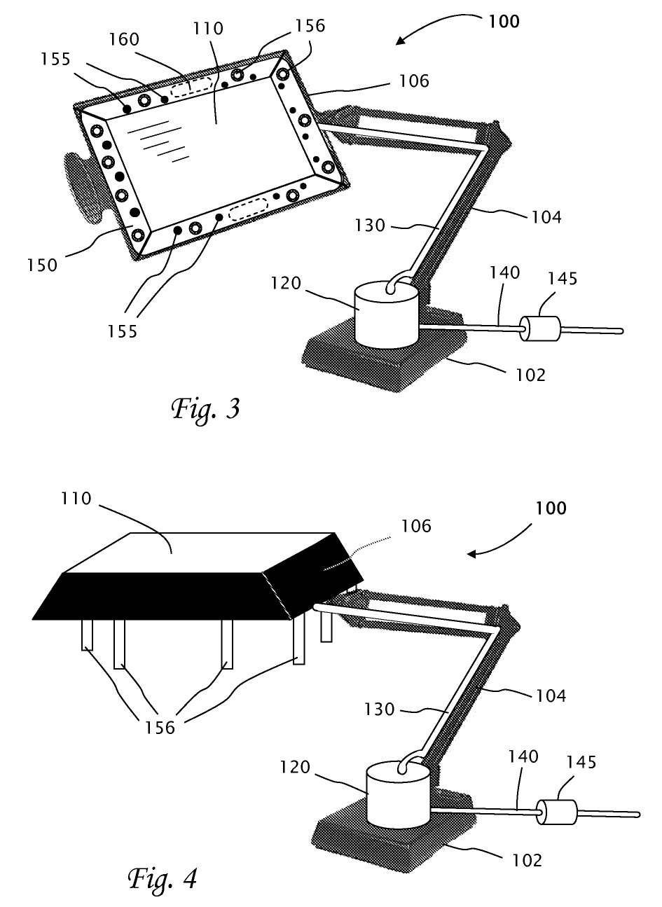

FIG. 3 is a front perspective view of a mechanical embodiment of a worker's workstation according to another embodiment of the present invention, showing the inside part of the active area, and FIG. 4 is a front perspective view of the same, but showing the outside part of the active area.

This embodiment is similar to the previous one, except that the rim area of frame 106′ is enlarged. Rim 106 or suction element 150′ thereon has a slope such that it better collects the rising fumes. It is also wide enough to optionally contain lighting means 160. The magnifying glass 110 blocks the fumes from rising further and makes it easier to removed from underneath it. Less suction power is thus required and sucking the fumes from the side can be quite efficient.

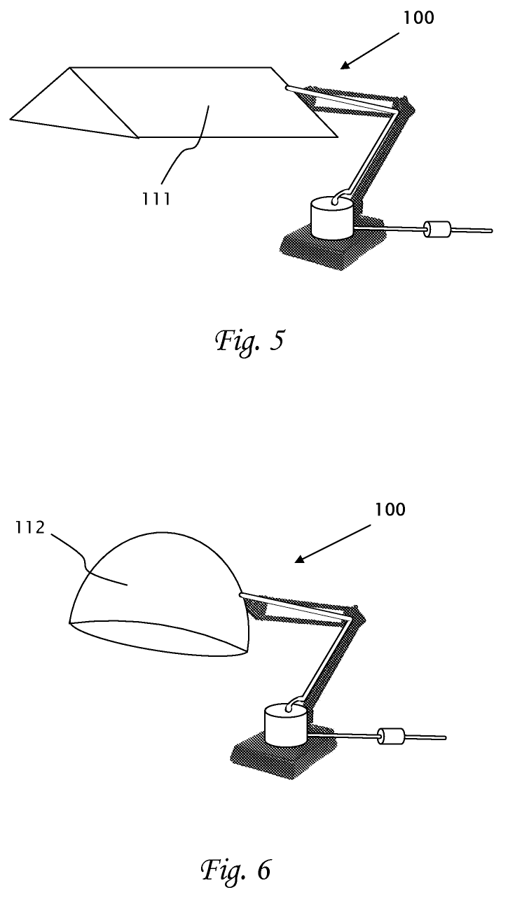

In other embodiments of the present invention, frame 106 and magnifying glass 110 may take other shapes. Two examples are illustrated in the embodiments shown in FIGS. 5 and 6. FIG. 5 depicts a magnifying glass 111 which has the shape of an A-frame, which enables to provide a magnifying glass to the manicurist as well as to the client, or to another worker and his work piece. FIG. 6 depicts a magnifying glass 112 which has the shape of a dome, which also enables to provide a magnifying glass 112 to both the manicurist and the client or worker and work piece. Both examples shown in FIGS. 5 and 6 also provide better blocking of the rising fumes and enable to suck them away with less suction power. The examples shown are for illustration only, and the present invention is not limited to the shown shapes, and the frame, glass and magnifying glass may take any shape.

Optionally, in another embodiment of the present invention the apparatus also includes a dust filter, positioned between the pump 120 and the suction holes 155 as illustrated in FIG. 6.

In another embodiment of the present invention the apparatus, rather than just including suction holes 155, may instead or in addition, include small hoses 156 hanging from the suction element 150, to be able to extract fumes from a lower level. This is illustrated in FIGS. 3 and 4.

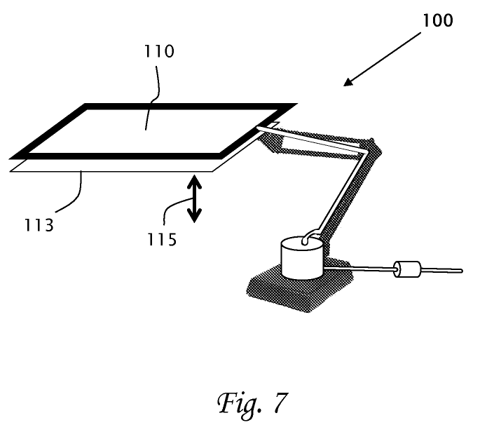

Referring to FIG. 7, yet another embodiment of the present invention is shown. In this embodiment, the magnifying glass 110′ maybe coupled with another lens 113 to provide the worker with focusing means, by moving lens 113 in directions 115.

In all embodiments, the magnifying glass 110 blocks the fumes from rising further and makes it easier to removed from underneath it. Less suction power is thus required and sucking the fumes from the side can be quite efficient. Suction of air from the top part is also possible but it blocks the worker's view of the working zone, whereas suction of air from the side provides the worker's with a clear view of the working zone.

In still another embodiment of the present invention the apparatus does not include a base but is rather hanging, for example, from the ceiling.

In another embodiment of the present invention the apparatus is designed for other professional workers that may inhale toxic fumes, such as workers that solder.

The invention being thus described in terms of several embodiments and examples, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A portable apparatus serving as a manicurist's workstation, comprising:
(a) one or more magnifying glasses and/or clear glasses, hereinafter referred to as magnifying glass, whereas the manicurist looks through said magnifying glass onto the working zone.
(b) a pump and a suction system to remove fumes, whereas said opening of the suction system is located below said magnifying glass and at its side, such that it does not block the manicurist's view of the working zone, preferably about the location where it is connected to said arm.

2. The apparatus according to claim 1 further comprises an illuminating mean to illuminate the working area.

3. The apparatus according to claim 1 further comprises an arm, which is preferably flexible.

4. The apparatus according to claim 1 further comprises a base.

5. The apparatus according to claim 1 wherein said suction system further comprises pipes and exhaust lines.

6. The apparatus according to claim 5 wherein said suction openings are holes located around the magnifying glass.

7. The apparatus according to claim 6 wherein said suction holes are elongated by suction sleeves are.

8. The apparatus according to claim 7 wherein said suction holes are sized to maximize the suction efficiency. For example, the holes which are further from the pump are larger then those closer to the pump.

9. A portable apparatus serving workers that may inhale toxic and other fumes, comprising:
(a) one or more magnifying glasses and/or clear glasses, hereinafter referred to as magnifying glass, whereas the worker looks through said magnifying glass onto the working zone.
(b) a pump and a suction system to remove fumes, whereas said opening of the suction system is located below said magnifying glass and at its side, such that it does not block the worker's view of the working zone, preferably about the location where it is connected to said arm.

10. The apparatus according to claim 9 further comprises an illuminating mean to illuminate the working area.

11. The apparatus according to claim 9 further comprises an arm, which is preferably flexible.

12. The apparatus according to claim 9 further comprises a base.

13. The apparatus according to claim 9 wherein said suction system further comprises pipes and exhaust lines.

14. The apparatus according to claim 13 wherein said suction openings are holes located around the magnifying glass.

15. The apparatus according to claim 14 wherein said suction holes are elongated by suction sleeves are.

16. The apparatus according to claim 15 wherein said suction holes are sized to maximize the suction efficiency. For example, the holes which are further from the pump are larger then those closer to the pump.
